(19) United States
(12) Patent Application Publication
(10) Pub. No.: US 2022/0045355 A1
(43) Pub. Date: Feb. 10, 2022

(54) GARNET-MGO COMPOSITE THIN MEMBRANE AND METHOD OF MAKING

(71) Applicant: Corning Incorporated, Corning, NY (US)

(72) Inventors: Michael Edward Badding, Campbell, NY (US); Yinghong Chen, Painted Post, NY (US); Aaron David DeGeorge, Painted Post, NY (US); Ying Shi, Painted Post, NY (US); Zhen Song, Painted Post, NY (US)

(21) Appl. No.: 17/395,846

(22) Filed: Aug. 6, 2021

Related U.S. Application Data
(60) Provisional application No. 63/063,680, filed on Aug. 10, 2020.

(51) Int. Cl. H01M 10/0562; H01M 10/0525; H01M 4/38; C04B 35/50

(52) U.S. Cl. CPC H01M 10/0562; H01M 10/0525; H01M 4/382; C04B 35/50; C04B 2235/77; C04B 2235/764; C04B 2235/3206; C04B 2235/6025; H01M 2300/0068

(57) ABSTRACT

A sintered composite ceramic, including: a lithium-garnet major phase; and a grain growth inhibitor minor phase, such that the grain growth inhibitor minor phase has a metal oxide in a range of 0.1 wt. % to 10 wt. % based on the total weight of the sintered composite ceramic.

### CROSS REFERENCE TO RELATED APPLICATIONS

This application claims the benefit of priority under 35 U.S.C. § 119 of U.S. Provisional Application Ser. No. 63/063,680, filed on Aug. 10, 2020, the content of which is relied upon and incorporated herein by reference in its entirety.

### BACKGROUND

### 1. Field

This disclosure relates to lithium-garnet composite ceramic electrolytes with improved critical current density (CCD).

### 2. Technical

Conventional lithium (Li)-ion batteries have been widely studied but still suffer from limited capacity density, energy density, and safety concerns, posing a challenge for large-scale application in electrical equipment. For example, while solid-state lithium batteries based on Li-garnet electrolyte (LLZO) address the safety concerns, insufficient contact between the Li anode and garnet electrolyte due to the rigid ceramic nature and poor lithium wettability of garnet, as well as surface impurities, often lead to large polarization and large interfacial resistances, thereby causing inhomogeneous deposition of lithium and lithium dendrites formation.

Thus, as a result of poor contact between the Li anode and garnet electrolyte, the battery may experience a low critical current density (CCD) and eventual short circuiting.

The present application discloses improved lithium-garnet composite ceramic electrolytes for enhanced grain boundary bonding of Li-garnet electrolytes in solid-state lithium metal battery applications.

### SUMMARY

In some embodiments, a sintered composite ceramic, comprises: a lithium-garnet major phase; and a grain growth inhibitor minor phase, wherein the grain growth inhibitor minor phase comprises a metal oxide in a range of 0.1 wt. % to 10 wt. % based on the total weight of the sintered composite ceramic.

In one aspect, which is combinable with any of the other aspects or embodiments, the lithium-garnet major phase comprises at least one of: (i) Li₇₋₃ₐLa₃Zr₂LₐO₁₂, with L═Al, Ga or Fe and 0<a<0.33; (ii) Li₇La_{3-b}Zr₂M_{b}O₁₂, with M═Bi, Ca or Y and 0<b<1; (iii) Li_{7-c}La₃(Zr_{2-c}, N_{c})O₁₂, with N═In, Si, Ge, Sn, Sb, Sc, Ti, Hf, V, W, Te, Nb, Ta, Al, Ga, Fe, Bi, Y, Mg, Ca, or combinations thereof and 0<c<1, or a combination thereof. In one aspect, which is combinable with any of the other aspects or embodiments, the lithium-garnet major phase comprises: Li_{7-c}La₃(Zr_{2-c}, N_{c})O₁₂, with N═Ta, Mg, or combinations thereof, and 0<c<1.

In one aspect, which is combinable with any of the other aspects or embodiments, the metal oxide comprises: MgO, CaO, ZrO₂, HfO₂, or a mixture thereof. In one aspect, which is combinable with any of the other aspects or embodiments, the metal oxide comprises MgO.

In one aspect, which is combinable with any of the other aspects or embodiments, the lithium-garnet major phase comprises at least 90 wt. % of a lithium garnet cubic phase. In one aspect, which is combinable with any of the other aspects or embodiments, a maximum grain size measured for a population of grains representing at least 5% of a total grain population does not exceed an average grain size of the total grain population by more than a multiple of 20.

In one aspect, which is combinable with any of the other aspects or embodiments, a membrane having a thickness in a range of 30-150 μm. In one aspect, which is combinable with any of the other aspects or embodiments, the membrane has a Li-ion conductivity of at least 10′ S/cm and a relative density of at least 90% of a theoretical maximum density of the membrane.

In one aspect, which is combinable with any of the other aspects or embodiments, a ceramic electrolyte comprises at least a sintered composite ceramic disclosed herein, wherein a critical current density (CCD) of battery cells comprising the ceramic electrolyte is at least 0.6 mA·cm⁻². In one aspect, which is combinable with any of the other aspects or embodiments, the CCD of the battery cells is at least 1.0 mA·cm⁻² at room temperature.

In some embodiments, a battery, comprises at least one lithium electrode; and an electrolyte in contact with the at least one lithium electrode, wherein the electrolyte is a lithium-garnet composite electrolyte comprising a sintered composite ceramic disclosed herein.

In some embodiments, a sintered composite ceramic, comprises: a lithium-garnet major phase; and a grain growth inhibitor minor phase, wherein the lithium-garnet major phase comprises: Li_{7-c}La₃(Zr_{2-c}, N_{c})O₁₂, with N═Ta, Mg, or combinations thereof, and 0<c<1, and the grain growth inhibitor minor phase comprises MgO in a range of 0.1 wt. % to 10 wt. % based on the total weight of the sintered composite ceramic.

In one aspect, which is combinable with any of the other aspects or embodiments, the lithium-garnet major phase comprises at least 90 wt. % of a lithium garnet cubic phase. In one aspect, which is combinable with any of the other aspects or embodiments, a maximum grain size measured for a population of grains representing at least 5% of a total grain population does not exceed an average grain size of the total grain population by more than a multiple of 20.

In one aspect, which is combinable with any of the other aspects or embodiments, a membrane having a thickness in a range of 30-150 μm. In some embodiments, a sintered composite ceramic, comprises: a lithium-garnet major phase; and a grain growth inhibitor minor phase, wherein the sintered composite ceramic comprises at least one of: a Li-ion conductivity of at least 10⁻⁴ S/cm; and relative density of at least 90% of a theoretical maximum density of the membrane.

In some embodiments, a method, comprises: a first mixing of inorganic source materials to form a mixture, including a lithium source compound and at least one transition metal compound; a first calcining conducted at a first temperature range of 800° C. to 1200° C.; a second calcining conducted at a second temperature range of 1000° C. to 1300° C.; a milling step of the mixture to reduce particle size; a sieving step to obtain a powder having at least one dimension in a range of 0.01 μm to 1 μm.

In one aspect, which is combinable with any of the other aspects or embodiments, the second calcining is conducted at a temperature greater than the first calcining.

In one aspect, which is combinable with any of the other aspects or embodiments, the method further comprises: passivating the powder by at least one of air carbonation and acid treatment; and heating a metal oxide at a third temperature range of 500° C. to 1500° C. In one aspect, which is combinable with any of the other aspects or embodiments, the air carbonation comprises: exposing the powder to air to form a protonated powder with an overlaying Li₂CO₃ shell. In one aspect, which is combinable with any of the other aspects or embodiments, the acid treatment comprises: exposing the powder to an acid solution to form a protonated powder.

In one aspect, which is combinable with any of the other aspects or embodiments, the method further comprises: a second mixing of the passivated powder, the metal oxide, and at least one solvent to form a slip composition; and tape casting the slip composition to form a green tape. In one aspect, which is combinable with any of the other aspects or embodiments, the second mixing further includes at least one of: organic binder, plasticizer, an excess lithium source, dispersant, or combinations thereof.

In one aspect, which is combinable with any of the other aspects or embodiments, the method further comprises: sintering the green tape at a fourth temperature range of 950° C. to 1500° C. to form a composite ceramic, comprising: a lithium-garnet major phase; and a grain growth inhibitor minor phase, wherein the sintered composite ceramic comprises at least one of: a Li-ion conductivity of at least 10⁻⁴ S/cm; and a relative density of at least 90% of a theoretical maximum density of the membrane.

In one aspect, which is combinable with any of the other aspects or embodiments, the sintering comprises: heating from room temperature to the fourth temperature range; holding at the fourth temperature range for a time in a range of 1-20 min; cooling from the fourth temperature range to room temperature, wherein: a heating ramp rate (HRR) for the heating step is 100° C./min<HRR<1000° C./min, and a cooling rate (CR) for the cooling step is 100° C./min<CR<1000° C./min. In one aspect, which is combinable with any of the other aspects or embodiments, the HRR is 250° C./min<HRR<750° C./min, the CR is 250° C./min<CR<750° C./min, and the fourth temperature range is 1100° C. to 1300° C.

In some embodiments, a method of forming a composite ceramic, comprises: forming a garnet powder including a lithium source compound and at least one transition metal compound; passivating the garnet powder by at least one of air carbonation and acid treatment; heating a metal oxide at a first temperature range of 500° C. to 1500° C.; forming a slip composition comprising the passivated garnet powder and metal oxide; tape casting the slip composition to form a green tape; sintering the green tape at a second temperature range of 950° C. to 1500° C. to form the composite ceramic.

In one aspect, which is combinable with any of the other aspects or embodiments, the slip composition further comprises at least one of: organic binder, plasticizer, an excess lithium source, dispersant, or combinations thereof.

In one aspect, which is combinable with any of the other aspects or embodiments, the air carbonation comprises: exposing the powder to air to form a protonated powder with an overlaying Li₂CO₃ shell. In one aspect, which is combinable with any of the other aspects or embodiments, the acid treatment comprises: exposing the powder to an acid solution to form a protonated powder.

In one aspect, which is combinable with any of the other aspects or embodiments, the sintering comprises: heating from room temperature to the second temperature range; holding at the second temperature range for a time in a range of 1-20 min; cooling from the second temperature range to room temperature, wherein: a heating ramp rate (HRR) for the heating step is 100° C./min<HRR<1000° C./min, and a cooling rate (CR) for the cooling step is 100° C./min<CR<1000° C./min. In one aspect, which is combinable with any of the other aspects or embodiments, the HRR is 250° C./min<HRR<750° C./min, the CR is 250° C./min<CR<750° C./min, and the second temperature range is 1100° C. to 1300° C.

### BRIEF DESCRIPTION OF THE DRAWINGS

The disclosure will become more fully understood from the following detailed description, taken in conjunction with the accompanying figures, in which:

FIG. 1 illustrates a process flow chart for making a metal oxide/LLZO composite thin membrane, according to some embodiments.

FIG. 2 illustrates a particle size distribution of an as-jet milled Ta-LLZO garnet powder, according to some embodiments.

FIG. 3 illustrates an x-ray diffraction (XRD) pattern of an as-jet milled Ta-LLZO garnet powder, according to some embodiments.

FIG. 4 illustrates thermal gravimetric analysis (TGA) analysis of air carbonated garnet and as-made garnet, according to some embodiments.

FIGS. 5A-5D illustrate cross-section scanning electron microscopy (SEM) images of garnet tapes comprising: 0 wt. % MgO sintered at 1200° C./3 min (FIG. 5A), 0 wt. % MgO sintered at 1250° C./3 min (FIG. 5B), 6 wt. % MgO sintered at 1200° C./3 min (FIG. 5C), and 6 wt. % MgO sintered at 1250° C./3 min (FIG. 5D), according to some embodiments. The green tape contains 50% excess lithium (Li).

FIG. 6 illustrates electrochemical impedance spectroscopy (EIS) analysis of garnet membranes with 6 wt. % MgO and 0 wt. % MgO, sintered at 1200° C./3 min and 1250° C./3 min, according to some embodiments.

FIGS. 7A-7D illustrate cross-section SEM images of garnet tapes comprising 3 wt. % MgO sintered at: 1200° C./3 min (FIGS. 7A and 7B), 1200° C./10 min (FIG. 7C), and 1250° C./10 min (FIG. 7D), according to some embodiments. The green tape contains 25% excess lithium (Li).

FIGS. 8A-8D illustrate cross-section SEM images of garnet tapes comprising 4 wt. % MgO sintered at: 1200° C./5 min (“fast firing”; FIGS. 8A and 8B) and 1250° C./5 min (FIGS. 8C and 8D), according to some embodiments. The green tape contains 20% excess lithium (Li).

FIG. 9 illustrates lattice constant changes as a function of Li₂O concentration for garnet membranes comprising 4 wt. % MgO and 0 wt. % MgO, according to some embodiments.

FIG. 10A-10C illustrate cross-section SEM images of sintered garnet tapes comprising 4 wt. % MgO (pre-sintered green tapes include 20% excess lithium) sintered at 1200° C./5 min in an Ar atmosphere using conventional sintering, according to some embodiments.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments. It should be understood that the present application is not limited to the details or methodology set forth in the description or illustrated in the figures. It should also be understood that the terminology is for the purpose of description only and should not be regarded as limiting.

Additionally, any examples set forth in this specification are illustrative, but not limiting, and merely set forth some of the many possible embodiments of the claimed invention. Other suitable modifications and adaptations of the variety of conditions and parameters normally encountered in the field, and which would be apparent to those skilled in the art, are within the spirit and scope of the disclosure.

### Definitions

“Major phase,” “first phase,” or like terms or phrases refer to a physical presence of a lithium garnet in greater than 50 wt. %. Phase components and their concentrations may be measured by XRD (wt. %). In some examples, major phase may also be represented by a physical presence of a lithium garnet in greater than 50 vol. % or greater than 50 mol. %, or like in the composition.

“Minor phase,” “second phase,” or like terms or phrases refer to a physical presence of a lithium dendrite growth inhibitor (i.e., grain boundary bonding enhancer) in less than 50% by weight, by volume, by mols, or like measures in the composition. In some examples, minor phases not detectable by XRD, may be measured by SEM to confirm existence of the minor phase(s).

“SA,” “second additive,” “second phase additive,” “second phase additive oxide,” “phase additive oxide,” “additive oxide,” “additive,” or like terms refer to an additive oxide that produces a minor phase or second minor phase within the major phase when included in the disclosed compositions.

“LLZO,” “garnet,” or like terms refer to compounds comprising lithium (Li), lanthanum (La), zirconium (Zr), and oxygen (0) elements. Optionally, dopant elements may substitute at least one of Li, La, or Zr.

For example, lithium-garnet electrolyte comprises at least one of: (i) Li₇₋₃ₐLa₃Zr₂LₐO₁₂, with L═Al, Ga or Fe and 0<a<0.33; (ii) Li₇La_{3-b}Zr₂M_{b}O₁₂, with M═Bi, Ca, or Y and 0<b<1; (iii) Li_{7-c}La₃(Zr_{2-c},N_{c})O₁₂, with N═In, Si, Ge, Sn, V, W, Te, Nb, or Ta and 0<c<1; (iv) Li₇₋ₓLa₃(Zr₂₋ₓ, Mₓ)O₁₂, with M═In, Si, Ge, Sn, Sb, Sc, Ti, Hf, V, W, Te, Nb, Ta, Al, Ga, Fe, Bi, Y, Mg, Ca, or combinations thereof and 0<x<1, or a combination thereof.

“Include,” “includes,” or like terms means encompassing but not limited to, that is, inclusive and not exclusive.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

For example, in modifying the quantity of an ingredient in a composition, concentrations, volumes, process temperature, process time, yields, flow rates, pressures, viscosities, and like values, and ranges thereof, or a dimension of a component, and like values, and ranges thereof, employed in describing the embodiments of the disclosure, “about” or similar terms refer to variations in the numerical quantity that can occur, for example: through typical measuring and handling procedures used for preparing materials, compositions, composites, concentrates, component parts, articles of manufacture, or use formulations; through inadvertent error in these procedures; through differences in the manufacture, source, or purity of starting materials or ingredients used to carry out the methods; and like considerations. The term “about” (or similar terms) also encompasses amounts that differ due to aging of a composition or formulation with a particular initial concentration or mixture and amounts that differ due to mixing or processing a composition or formulation with a particular initial concentration or mixture.

As utilized herein, “optional,” “optionally,” or the like are intended to mean that the subsequently described event or circumstance can or cannot occur, and that the description includes instances where the event or circumstance occurs and instances where it does not occur. The indefinite article “a” or “an” and its corresponding definite article “the” as used herein means at least one, or one or more, unless specified otherwise.

As used herein, “room temperature” or “RT” is intended to mean a temperature in a range of about 18° C. to 25° C.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

Abbreviations, which are well known to one of ordinary skill in the art, may be used (e.g., “h” or “hrs” for hour or hours, “g” or “gm” for gram(s), “mL” for milliliters, and “RT” for room temperature, “nm” for nanometers, and like abbreviations).

Specific and preferred values disclosed for components, ingredients, additives, dimensions, conditions, times, and like aspects, and ranges thereof, are for illustration only; they do not exclude other defined values or other values within defined ranges. The compositions, articles, and methods of the disclosure can include any value or any combination of the values, specific values, more specific values, and preferred values described herein, including explicit or implicit intermediate values and ranges.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

As explained above, solid-state lithium batteries based on Li-garnet electrolyte (LLZO) often suffer from insufficient contact between the Li anode and garnet electrolyte, which often leads to the battery experiencing a low critical current density (CCD) and eventual short circuiting. Conventional approaches to address these issues have included: (A) H₃PO₄ acid treatments for removing impurities while forming a protective interlayer of Li₃PO₄ and (B) modifying the electrolyte-anode interface with SnO₂ and MoS₂ to form Sn, Mo, and related alloy interlayers. However, it was found that for these proposals, as the battery circulates, the interlayers gradually become exhausted and result in eventual battery failure. Moreover, these interlayers do not increase the resistance of the electrolyte itself against lithium dendrite growth.

Composite ceramic electrolytes are effective in improving bonding at the major phase grain boundary, thereby improving CCD by minimizing lithium dendrite growth. Critical current density (CCD) refers to the maximum current density that LLZO electrolyte can tolerate before lithium dendrite penetration occurs in the electrolyte, which affects the dendrite suppression capability of the electrolyte. By adding additives during the LLZO sintering process, the additive or its decomposition product aggregates at the grain boundary to enhance grain boundary bonding and block lithium dendrite growth. Current efforts at studying additives have included (i) LiOH·H₂O in LLZO to form a minor phase of Li₂CO₃ and LiOH or (ii) adding Li₃PO₄ to LLZO precursor and allowing Li₃PO₄ to remain as the minor phase at the grain boundaries by controlling sintering conditions or (iii) adding LiAlO₂-coated LLZO particles to obtain a Li-garnet composite ceramic electrolyte. However, none of (i) to (iii), can achieve a desired CCD to meet the requirements of practical applications.

Garnet is a promising solid electrolyte material for Li-metal battery technology. Li metal anodes allow a much higher energy density than the carbon anodes currently used in conventional Li-ion batteries. Challenges exist in methods of making thin garnet materials. For example, one challenge is Li-dendrite formation, as explained above. A second challenge is the strength requirement for thin membranes, which is determined by battery assembly handling. A fine grain microstructure is desired for high strength.

Disclosed herein is a Li-garnet composite ceramic thin membrane for electrolyte applications prepared by adding a metal oxide (e.g., MgO) into LLZO with optional elemental doping (e.g., at least one of In, Si, Ge, Sn, Sb, Sc, Ti, Hf, V, W, Te, Nb, Ta, Al, Ga, Fe, Bi, Y, etc., or combinations thereof). Elemental dopants may be used to stabilize LLZO into a cubic phase.

In some examples, the Li-garnet composite ceramic may comprise: a lithium garnet major phase (e.g., LLZO, as defined above) and a grain growth inhibitor minor phase (e.g., SA, as defined above). In some examples, the major phase may be doped with at least one of In, Si, Ge, Sn, Sb, Sc, Ti, Hf, V, W, Te, Nb, Ta, Al, Ga, Fe, Bi, Y, Mg, Ca, or combinations thereof and the minor phase comprises a second additive oxide selected from the group MgO, CaO, ZrO₂, HfO₂, or a mixture thereof, present in from 0.1-10 wt. % based on the total amount of the ceramic. The additive may improve uniformity of the ceramic microstructure and enhance mechanical properties of the ceramic. As used herein “uniformity of the ceramic microstructure” refers to the distribution of grain sizes. The occurrence of abnormally large grains, which can have a detrimental effect on mechanical properties, may be minimized or eliminated and a fine grain microstructure may be achieved. For example, the maximum grain size measured for a population of grains representing at least 5% of the total grains should not exceed the average grain size by more than a multiple of 20.

As disclosed herein, a process of making a dense, fine-grain metal oxide/garnet composite thin membrane structure is described with an identified composite composition that results in a test cell having improved CCD, as compared with cells not comprising the metal oxide/garnet composite thin membrane.

The following Examples demonstrate making, use, and analysis of the disclosed ceramics.

### EXAMPLES

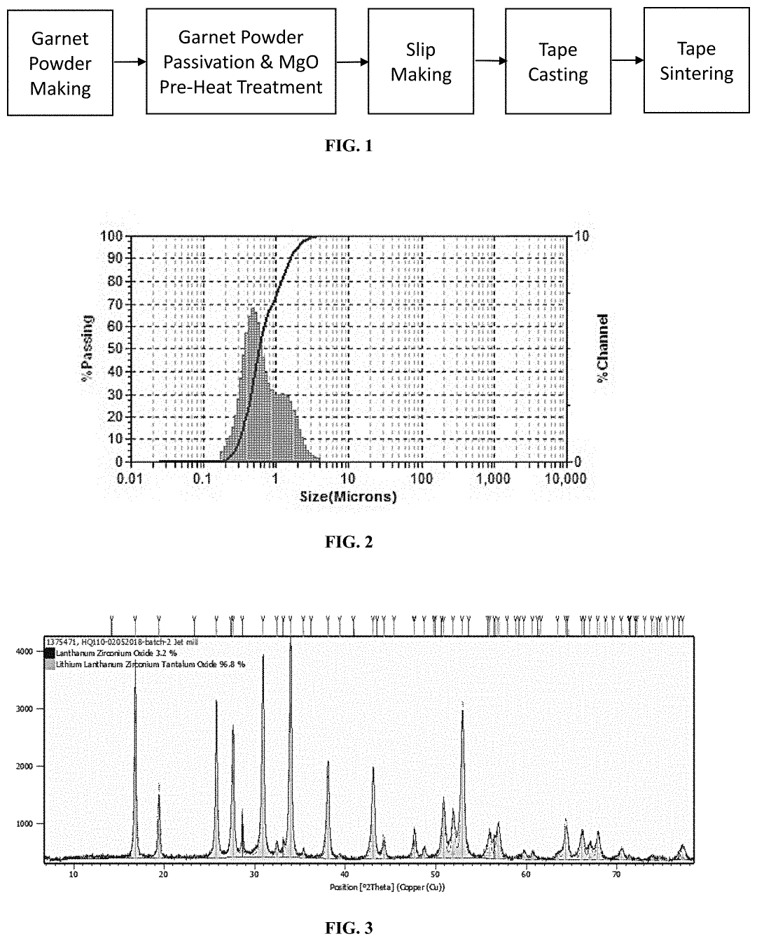

FIG. 1 illustrates a process flow chart for making a metal oxide/LLZO composite thin membranes, according to some embodiments.

### Example 1A

### Preparation of Li-Garnet Composite Ceramic Powder (Garnet Powder Making)

Step 1: First Mixing Step

In the first mixing step, a stoichiometric amount of inorganic materials is mixed together, in the formula of garnet oxides and, for example, milled into fine powder. The inorganic materials can be a carbonate, a sulfonate, a nitrate, an oxalate, a hydroxide, an oxide, or mixtures thereof with the other elements in the chemical formula. For example, the inorganic materials can be, for example, a lithium compound and at least one transition metal compound (e.g., La-based, Zr-based, etc.). In some embodiments, the inorganic materials compounds may also comprise at least one of In, Si, Ge, Sn, Sb, Sc, Ti, Hf, V, W, Te, Nb, Ta, Al, Ga, Fe, Bi, Y, Mg, Ca, or combinations thereof in the chemical formula.

In some embodiments, it may be desirable to include an excess of a lithium source material in the starting inorganic batch materials to compensate for the loss of lithium during the high temperature of from 1000° C. to 1300° C. (e.g., 1100° C. to 1200° C.) sintering/second calcining step. The first mixing step can be a dry mixing process (e.g., tubular mixing followed by dry ball milling, or vice versa), dry milling process, or a wet milling process with an appropriate liquid that does not dissolve the inorganic materials. The mixing time, such as from several minutes to several hours, can be adjusted, for example, according to the scale or extent of the observed mixing performance (e.g., 1 min to 48 hrs, or 30 mins to 36 hrs, or 1 hr to 24 hrs (e.g., 12 hrs), or any value or range disclosed therein). The milling can be achieved by, for example, a planetary mill, an attritor, ball mixing, tubular mixing, or like mixing or milling apparatus.

Step 2: First Calcining Step

In the first calcining step, the mixture of inorganic material, after the first mixing step, is calcined at a predetermined temperature, for example, at from 800° C. to 1200° C. (e.g., 950° C.), including intermediate values and ranges, to react and form the target Li-garnet. The predetermined temperature depends on the type of the Li-garnet. The calcination time, for example, varies from 1 hr to 48 hrs (e.g., 2 hrs to 36 hrs, or 3 hrs to 24 hrs, or 4 hrs to 12 hrs (e.g., 5 hrs), or any value or range disclosed therein), and also may depend upon on the relative reaction rates of the selected inorganic starting or source batch materials. In some examples, the predetermined temperature is selected independently from the calcination time, for example, 950° C. for 5 hrs or 1200° C. for 5 hrs. In some embodiments, a pre-mix of inorganic batch materials can be milled and then calcinated or calcined, as needed, in a first step.

Step 3: Second Calcining Step

After the first calcining step, the calcined mixture of inorganic material may be calcined at a higher predetermined temperature for example, at from 1000° C. to 1300° C. (e.g., 1200° C.), including intermediate values and ranges, with a temperature ramping rate (pre-sintering) and cooling rate (post-sintering) ranging from 0.5° C./min to 10° C./min (e.g., 5° C./min). The predetermined temperature for the second calcining depends on the type of the Li-garnet. The calcination time, for example, varies from 1 hr to 48 hrs (e.g., 2 hrs to 36 hrs, or 3 hrs to 24 hrs, or 4 hrs to 12 hrs (e.g., 5 hrs), or any value or range disclosed therein).

In some examples, Steps 2 and 3 may be combined into a single calcining step with two holding phases (the first holding phase represented by Step 2 and the second holding phase represented by Step 3).

Step 4: Milling Step

After the second calcining step, the powder may be milled by ball milling and/or jet milling with 90 wt. % of the above lithium garnet cubic phase. When ball milling is conducted, the ball milled powder is coarser, having a D50 particle size ranging between 1-5 μm. When jet milling is conducted, the jet milled powder is finer, having a D50 particle size ranging between 0.01-1 μm. Both the coarse and fine powders have approximately a bi-modal particle size distribution. For tape casting, a finer powder having a mono-modal distribution is preferred.

Step 5: Sieving Step

The milled powder of Step 4b is then filtered by passing through a 100-grit sieve to obtain a final Li-garnet composite ceramic powder having a D50 particle size ranging between 0.01-1 μm (e.g., 0.6 μm). Where the powder is formed as an arbitrary shape, the powder may have at least one dimension ranging from 0.01-1 μm.

### Example 1B

Garnet powder is prepared by a solid-state reaction method, using Li₂CO₃, La₂O₃, ZrO₂ and the corresponding dopant oxides as the precursors (e.g., Ta-based). Because the powders absorb different amounts of adsorbates, the powders (except Li₂CO₃) are measured using TGA (RT-1000C) before batching, and then batched in the amount of powder considering the adsorbates amount.

A stoichiometric batch is thoroughly mixed by tubular mixing, followed by ball mixing, and then heated in a single calcining step with a first holding phase conducted at 950° C. for 5 hrs and a second holding phase conducted at 1200° C. for 5 hrs in a Pt crucible with a Pt cover sheet. After calcination, the chunk product is jet milled and then sieved with a 100-grit sieve to obtain a final garnet powder with a D50 of about 0.6 μm. FIG. 2 illustrates a particle size distribution of an as-jet milled Ta-LLZO garnet powder. FIG. 3 illustrates an x-ray diffraction (XRD) pattern of an as-jet milled Ta-LLZO garnet powder.

### Example 2

### Garnet Powder Passivation & Metal Oxide Pre-Heat Treatment

In some embodiments, prior to slip preparation (explained in greater detail below), the garnet powder prepared in Examples 1A or 1B (e.g., Ta-doped LLZO) may be air carbonated or acid treated to passivate its high reactivity with other tape casting slip components. This allows the garnet to be stable when tape casting the slip and as a result, the final green tape may be stable for extended periods of time. In addition, the minor or second phase metal oxide additive may be exposed to a pre-heat treatment prior to tape casting to remove any embedded volatile components. This results in smoother tape surface morphologies post-tape casting processing.

Garnet Powder Passivation by Air Carbonation

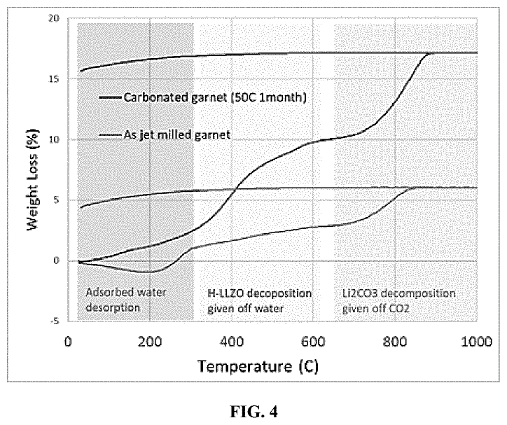

As-made garnet powder (of Examples 1A or 1B) is exposed to air at 50° C. for 1 month. The powder reacts with H₂O and CO₂ in air to form H-LLZO (inner core; H-doped LLZO), with an overlaying Li₂CO₃ outer shell on the garnet powder particles. As stated above, this passivates garnet to prevent garnet reaction with organic components in the slip composition and when tape casting the slips. FIG. 4 illustrates thermal gravimetric analysis (TGA) analysis of air carbonated garnet and as-made (jet milled) garnet. Results indicate that water desorption from 300° C. to 600° C., and CO₂ desorption from 600° C. to 900° C. are detected, corresponding to decomposition of H-LLZO and Li₂CO₃, respectively. Carbonated powder contains more of these species.

Garnet Powder Passivation by Acid Treatment

In a separate passivation technique, hydrochloric acid (˜0.4M HCl) is added to a slurry of the as-made garnet powder (of Examples 1A or 1B). Initially, pH of the slurry exceeds 7, but this value gradually decreases by addition of HCl until settling to a desired pH of around 6. Centrifuging the slurry separates the final powder. The obtained testing powder is 3H-Li_{3.5}La₃Zr₂Ta_{0.6}O₁₂ (protonated garnet) (i.e., no outer shell formation—one composition of protonated garnet). H-LLZO (protonated garnet) is stable with the tape casting slip.

Metal Oxide Pre-Heat Treatment

In some examples, magnesium oxide (MgO) from American Element is used as the metal oxide precursor and is heat treated in a dry atmosphere at a temperature in a range of 700° C. to 1250° C., or 750° C. to 1250° C., or 700° C. to 1000° C. (e.g., 800° C.), or any value or sub-range therein for a time in a range of 0.1 hr to 5 hrs, or 1 hr to 3 hrs (e.g., 2 hrs), or any value or sub-range therein to remove any embedded volatile components, such as Mg(OH)2, which can dissolve in tape casting slip solvents. Too high a temperature causes the MgO nano-powder to agglomerate or sinter while too low a temperature would fail to remove the volatile components.

### Example 3

### Slip Making

In embodiments, the tape casting process begins by making a garnet slip composition. The slip contains at least one solvent, organic binder, plasticizer, lithium garnet powder, an excess lithium source, second additive, and dispersant. A typical slip composition formulation is listed in Table 1, though the lithium garnet powder, an excess lithium source, second additive, and binder content may be varied for achieving a variety of high quality green tapes.

TABLE 1

| | | | Solvent Vol. % |
|---|---|---|---|
| Component | Name | Vol. % in tape | in slip |
| Li-garnet powder | Ta-based LLZO | 52.28 | |
| Excess Li source | Li₂CO₃ | | |
| Second additive | MgO | | |
| Dispersant | Dispersebyk 118 | 6.99 | |
| Solvent 1 | n-Butyl propionate | | 65.55% |
| Solvent 2 | n-Propyl propionate | | |
| Binder | Elvacite 2046 | 27.93 | |
| Plasticizer | Dibutyl Phthalate | 12.80 | |

Slip making includes steps of dispersing the lithium garnet powder, an excess lithium source, and second additive in the solvents to form a garnet suspension, adding the dispersant, binder, and plasticizer to the garnet suspension, milling (e.g., attrition milling at 2000 rpm for 1-5 hrs (e.g., 2 hrs)) and mixing under vacuum and chilling for 5 to 10 min. The milling and mixing may be conducted under vacuum and chilling to prevent inadvertent reaction between the garnet and other slip components.

### Example 4

### Tape Casting

The tape casting process includes, for example, slip making (described above), tape casting, and drying (sintering, described below). Tape casting may be conducted using a 6 mil to 18 mil blade, for example.

Green Tape With and Without Garnet Powder Passivation (Example 2)

In some examples, the tape casting slip composition of Table 1 was used, with the garnet powder mixed with excess Li precursor (such as Li₂CO₃, LiOH, etc.), and heated to 950° C. for 2 hrs in an inert environment (N2). After the powder has cooled, it is tape cast immediately. The resultant green tape becomes fragile in less than one week. The garnet powder was not passivated either by air carbonation or acid treatment.

In some examples, the tape casting slip composition of Table 1 was used, with the garnet powder passivated by carbonation in air at 50° C., as in Example 2. The resultant green tape retains its physical characteristics for several months.

In some examples, the tape casting slip composition of Table 1 was used, with the garnet powder passivated by acid treatment, as in Example 2. Thereafter, an excess lithium source (e.g., Li₂CO₃) is mixed therein and tape cast with the slip composition of Table 1. The resultant green tape retains its physical characteristics for several months.

### Example 5

### Tape Sintering

In some examples, sintering of laminated tape in argon calls for several conditions. First, the tape is placed on a garnet setter, such as a grafoil (flexible graphite) setter comprising a top plane and a bottom plane with the laminated tape sandwiched therein.

Second, an optional mother powder is preferably the same composition as the garnet powder when the tape is placed around the setter or near the tape to compensate for the loss of Li in the tape during sintering. A mother powder may not be necessary for all garnet compositions. The need for a mother powder thus, depends on the composition. For example, in a lithium rich composition, a mother powder is not needed. For a lithium deficient composition, the tape may need to be buried in a mother powder.

Third, an open environment may be used to in the sintering process with the tape, the setter, and the optional mother powder, such as in an inverted platinum crucible firing apparatus whereby a bottom support is a platinum sheet, the garnet setter is placed on top of the sheet along with the optional mother powder, and the platinum crucible contacts the bottom platinum sheet. At low temperature, the gap between the crucible and sheet can release evolved gas, while at high temperature (greater than 800° C.), the gap is closed because of a weight on the top of platinum crucible.

Comparison of Sintering Processes

Conventional sintering involves a heating and/or cooling ramp rate of 1-10° C./min (60-600° C./hr), while the sintering process described in the present application (i.e., “fast firing”) involves a heating and/or cooling ramp rate of 100-600° C./min.

As disclosed herein, thin garnet tape is formed by adding excess Li (e.g., as in a form of Li₂CO₃) into the green tape to compensate for Li loss during sintering to obtain a densely sintered structure (i.e., relative density >98%) with high cubic garnet phase concentration (close to 100%). Fast firing suppresses Li-loss by shorten temperature ramping time (Li-loss is significant when temperature is greater than 900° C.). With Li-loss sufficiently reduced, the needed excess Li in green tape may also be reduced. For example, in a 0.5Ta-LLZO green tape of about 100 μm thickness, (A) when firing in argon, only a 5-10% excess Li is needed in fast firing while more than 20% excess Li is needed in conventional sintering; or (B) when firing in ambient air, only about 15-20% excess Li is needed in fast firing while more than 50% excess Li is needed in conventional sintering.

### Comparison Example

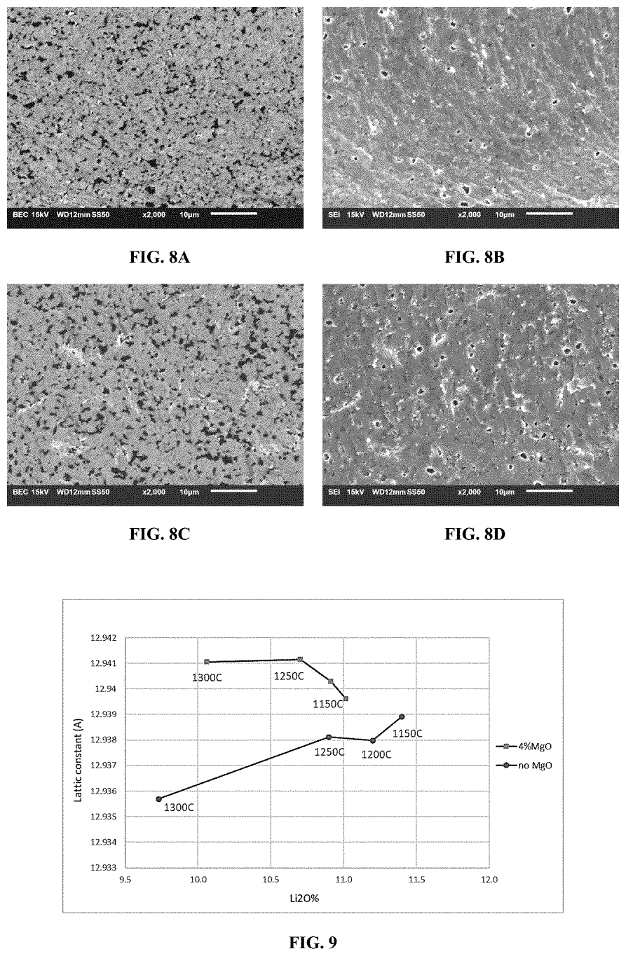

In a conventional sintering example, green tape comprising 4 wt. % MgO and 20% excess lithium (Li) (for which fast firing is explained in FIGS. 8A-8D) is sintered. In order to reduce Li loss (as is often seen in conventional sintering, explained above), (1) green tape thickness was increased by using a two-layered lamination (formed by pressing with 30 MPa of force at 50° C. for 1 hr) such that this thicker tape has a lower specific surface area and (2) an argon gas environment was used as the firing atmosphere. The conventional temperature schedule was used: RT to 650° C. (heating ramp rate: 120° C./hr); 650° C. hold for 1 hr; 650° C. to 1200° C. (heating ramp rate: 200° C./hr); 1200° C. hold for 5 min; 1200° C. to RT (cooling rate: 200° C./hr).

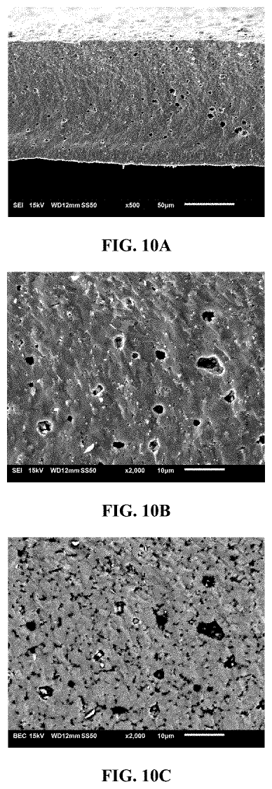

FIG. 10A-10C illustrate cross-section SEM images of sintered garnet tapes comprising 4 wt. % MgO (pre-sintered green tapes include 20% excess lithium) sintered at 1200° C./5 min in an Ar atmosphere using conventional sintering. Tape thickness is 125 μm. The garnet grains are well sintered; however, large pores are seen within the tape (see black spots of FIGS. 10B and 10C). Comparing to the sintered tapes of FIGS. 8A and 8B (fast firing of green tape (having 20% excess Li) at 1200° C./5 min; sintered garnet tape has 4 wt. % MgO), smaller pores are observed when fast firing is conducted. Thus, this demonstrates that fast firing has a much effect on reducing Li-loss during sintering, which enables garnet tape sintering at hasher conditions.

X-ray diffraction analysis of the tape from FIGS. 10A-10C yielded the phase concentration and lattice constant, as shown in Table 2.

TABLE 2
Conventional sintering: 1200° C./5 min of green tape with
20% excess Li (4 wt. % MgO)

| Phase quantification | Lattice constant of garnet (Å) |
|---|---|
| 97.7 wt. % cubic garnet | 12.93878 +/− 0.00004 |
| 2.3 wt. % La₂LiTaO₆ | |

In all XRD lattice constant measurements, LaB6 was added into the powder as an internal label. Lattice constants of the conventionally fired tape are close to the original Ta-LLZO powder. This indicates that a slow firing process (e.g., heating rate), and especially a slow cooling process (cooling rate), cannot yield a sintered garnet with Mg in the garnet lattice. As a result, the final sintered tape is a MgO/Ta-LLZO composite, and not MgO/Mg-Ta-LLZO (as is achieved by fast firing). Other than a lattice constant difference, the conventionally-sintered thicker tape also has a lower cubic garnet phase than the fast fired thinner tape, which has 100 wt. % cubic phase.

In some examples, the fast firing sintering disclosed herein may comprise a first binder burnout in argon, comprising: RT to 800° C. (heating ramp rate: 250° C./min); 800° C. hold for 5 min; 800° C. to RT (cooling rate: 250° C./min). Thereafter, the binder burned out tapes were then sintered in air with the following schedule: RT to predetermined temperature (heating ramp rate: 400° C./min); hold at predetermined temperature for 1-20 min; predetermined temperature to RT (cooling rate: 400° C./min). The predetermined temperature comprises a temperature in a range of 950° C. to 1500° C. or 1100° C. to 1300° C.

Garnet Tape Sintering Condition 1

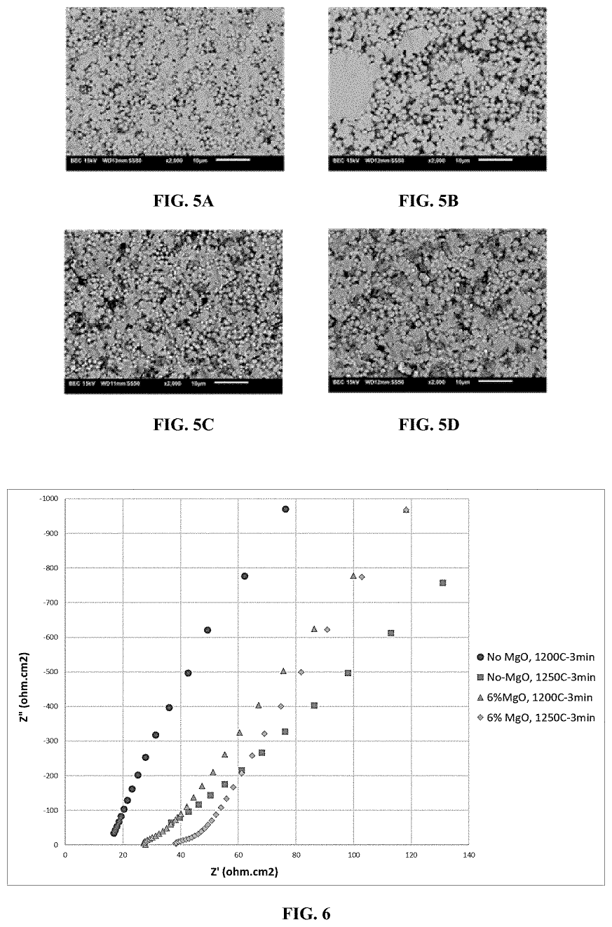

Garnet green tapes were sintered in air with a temperature ramping speed of 450° C./min. FIGS. 5A-5D illustrate cross-section scanning electron microscopy (SEM) images of about 100 μm thick garnet tapes comprising: 0 wt. % MgO sintered at 1200° C./3 min (FIG. 5A), 0 wt. % MgO sintered at 1250° C./3 min (FIG. 5B), 6 wt. % MgO sintered at 1200° C./3 min (FIG. 5C), and 6 wt. % MgO sintered at 1250° C./3 min (FIG. 5D), according to some embodiments. The green tape contains 50% excess lithium (Li).

When sintered at 1250° C. for 3 min, the 0 wt. % MgO tapes develop coarse, large grains (FIG. 5B), while tapes with MgO added, no large grains are observed at either sintering condition (FIGS. 5C and 5D), with those measured being significantly smaller than the grains of the 0 wt. % MgO tapes. This indicates that MgO does help to prevent abnormal and relatively large grain growth in garnet. Fine grain structure is essential for high strength thin membranes. Darker features in the 6 wt. % MgO added tape images (FIGS. 5C and 5D) are due to MgO inclusion.

FIG. 6 illustrates electrochemical impedance spectroscopy (EIS) analysis of garnet membranes with 6 wt. % MgO and 0 wt. % MgO, sintered at 1200° C./3 min and 1250° C./3 min, according to some embodiments. Specifically, the EIS curves are measured on the test samples shown in FIGS. 5A-5D using gold (Au) electrodes. Li-ion conductivities calculated FIG. 6 are tabulated in Table 3 below. All samples' Li-ion conductivity are in the same, mid-10⁻⁴ S/cm range. When a second phase is added at the grain boundary, it is expected Li-ion conductivity would severely decrease. However, Table 3 unexpectedly shows that by adding 6 wt. % MgO, Li-ion conductivity only slightly decreases at 1200° C./3 min sintering condition and does not adversely affect cell performance. On the contrary, existence of a second phase increases CCD in cell performance.] In each instance, the green tape contains 50% excess Li.

TABLE 3

| | 0 wt. % MgO | 6 wt. % MgO |
|---|---|---|
| 1200° C./3 min | 5.1 × 10⁻⁴ S/cm | 3.8 × 10⁻⁴ S/cm |
| 1250° C./3 min | 3.6 × 10⁻⁴ S/cm | 3.4 × 10⁻⁴ S/cm |

Table 4 discloses the XRD-measured phase compositions of the thin garnet membranes from sintering condition 1. All samples have high concentrations of cubic garnet phase. High cubic phase ensures a high ionic conductivity. The presence of La₂Zr₂O₇, LiLa₂O_{3.5}, La₂O₃, etc. are auxiliary products of garnet decomposition. These are different from the desired MgO second phase, which stays at grain boundaries or the tri-boundary points. These auxiliary products appear as large agglomerates (multiple garnet grains size) and pores in the sintered tapes. An excess of the auxiliary products leads conductivity decreases and weaker tape strength.

TABLE 4

| | 0 wt. % MgO | 6 wt. % MgO |
|---|---|---|
| 1200° C./3 min | 99 wt. % cubic garnet | 97 wt. % cubic garnet |
| | 0.5 wt. % La₂Zr₂O₇ | 2 wt. % LiLa₂O_{3.5} |
| | 0.5 wt. % LiLa₂O_{3.5} | 1 wt. % La₂O₃ |
| 1250° C./3 min | 99 wt. % cubic garnet | 94 wt. % cubic garnet |
| | 1.0 wt. % LiLa₂O_{3.5} | 3 wt. % LiLa₂O_{3.5} |
| | | 2 wt. % La₂O₃ |
| | | 1 wt. % MgO |

Garnet Tape Sintering Condition 2

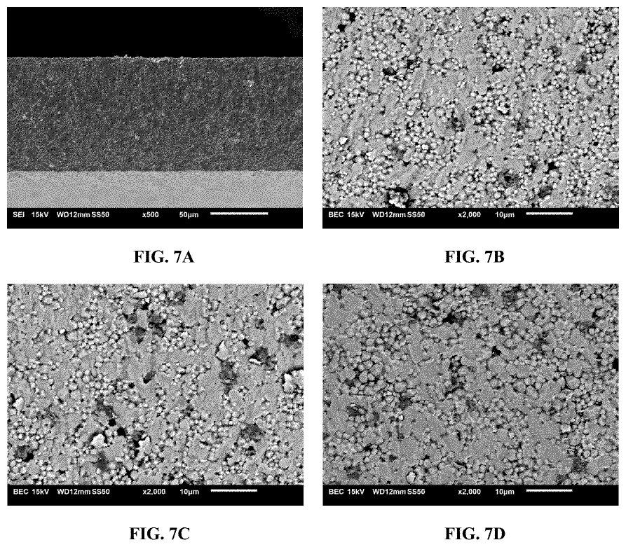

Garnet powder passivated by air carbonation was mixed with Li₂CO₃ and with 3 wt. % MgO (additional percentage over garnet powder). Tapes having a thickness of about 80-90 μm (e.g., 81 μm) are sintered at different temperatures and durations. FIGS. 7A-7D illustrate cross-section SEM images of garnet tapes comprising 3 wt. % MgO sintered at: 1200° C./3 min (FIGS. 7A and 7B), 1200° C./10 min (FIG. 7C), and 1250° C./10 min (FIG. 7D), according to some embodiments. The green tape contains 25% excess lithium (Li). FIGS. 7A-7D generally show MgO exists as a second phase (blackish features) and that it does not alter garnet microstructure, which is why the tape has high ionic conductivity.

Li-ion conductivities of garnet membranes prepared by sintering condition 2 are shown in Table 5 while XRD-measured phase compositions and lattice constants of the same are in Table 6. Table 6 also includes data for a sample without any added MgO.

With respect to Table 5, all samples' Li-ion conductivity are in the same, mid-10⁴ S/cm range. The MgO content is shown to affect Li-ion conductivity; lower MgO contents leads to higher conductivity (compare 3 wt. % MgO vs. 6 wt. % MgO). With respect to Table 6, the MgO-added tapes have a higher lattice constant than the non-MgO added tape. This indicates that Mg is doped into the garnet. Therefore, the final sintered tape composites comprise a MgO minor phase and a Mg-Ta-LLZO major phase. The minor MgO phase is not detected by XRD due to a too small amount present and a too small particle size. However, MgO is observable in the back-scattered SEM images of FIGS. 7A-7D, which are shown as the dark features.

TABLE 5

| | Ionic Conductivity |
|---|---|
| 3 wt. % MgO, 25% excess Li | (S/cm) |
| 1200° C./3 min | 5.64 × 10⁻⁴ |
| 1200° C./10 min | 5.76 × 10⁻⁴ |
| 1250° C./3 min | 5.66 × 10⁻⁴ |

TABLE 6

| | | Lattice constant of |
|---|---|---|
| | Phase quantification | garnet (Å) |
| 3 wt. % MgO, | 98.74 wt. % cubic garnet | 12.94512 +/− 0.00006 |
| 1200° C./3 min | 1.26 wt. % ZrO₂ | |
| 3 wt. % MgO, | 98.90 wt. % cubic garnet | 12.94632 +/− 0.00005 |
| 1200° C./10 min | 1.10 wt. % ZrO₂ | |
| 3 wt. % MgO, | 98.74 wt. % cubic garnet | 12.94544 +/− 0.00005 |
| 1250° C./3 min | 1.26 wt. % ZrO₂ | |
| 0 wt. % MgO, | 98.77 wt. % cubic garnet | 12.93744 +/− 0.00006 |
| 1200° C./5 min | 1.23 wt. % ZrO₂ | |

Garnet Tape Sintering Condition 3

Garnet thin membranes are made from a green tape sintered in air. Garnet powder passivated by air carbonation was mixed with Li₂CO₃ and with 4 wt. % MgO (additional percentage over garnet powder). Tapes of about 70 μm are sintered at different temperatures. FIGS. 8A-8D illustrate cross-section SEM images of garnet tapes comprising 4 wt. % MgO sintered at: 1200° C./5 min (FIGS. 8A and 8B) and 1250° C./5 min (FIGS. 8C and 8D), according to some embodiments. The green tape contains 20% excess lithium (Li). From FIGS. 8A-8D, stated generally, it is shown that with a lower excess Li amount, MgO is more uniformly distributed in the garnet matrix.

XRD-measured phase compositions, lattice constants, and Li₂O concentrations (measured by inductively coupled plasma, ICP, analysis) of garnet membranes prepared by sintering condition 3 (Ta-LLZO+4 wt. % MgO) are shown in Table 7 (for reference, BBO represents ‘binder burn out’). Comparison garnet thin membranes (Ta-LLZO) without MgO addition were also made with the same tape casting slip composition as in Table 1 and tape sintering conditions.

TABLE 7

| Firing | Ta-LLZO + 4 wt. % MgO (20% excess Li) | | | Ta-LLZO (20% excess Li) | | |
|---|---|---|---|---|---|---|
| condition | Cubic | Lattice constant | | Cubic | Lattice constant | |
| 800° C./6 min | garnet | of cubic garnet | | garnet | of cubic garnet | |
| BBO in Ar | (wt. %) | (Å) | Li₂O % / garnet | (wt. %) | (Å) | Li₂O % / garnet |
| 1150° C./5 min | 100 | 12.93960 | 11.0% | 100 | 12.93892 | 11.4% |
| 1200° C./5 min | 100 | 12.94029 | 10.9% | 85.7 | 12.93798 | 11.2% |
| 1250° C./5 min | 97.2 | 12.94115 | 10.7% | 88.6 | 12.93812 | 10.9% |
| 1300° C./5 min | 91.8 | 12.94106 | 10.1% | 84.62 | 12.93569 | 9.7% |
| 1350° C./5 min | 74.4 | 12.93376 | | 77.0 | 12.93643 | |

In a similar trend as explained above, the MgO-added garnet membranes have a higher lattice constant than the non-MgO added membranes, meaning that the major phase are different materials. This indicates that Mg is doped into the garnet and thus, the final sintered tape composites comprise a MgO minor phase and a Mg-Ta-LLZO major phase. The minor MgO phase is not detected by XRD due to a too small amount present and a too small particle size. However, MgO is observable in the back-scattered SEM images of FIGS. 8A-8D, which are shown as the dark features.

FIG. 9 illustrates lattice constant changes as a function of Li₂O concentration for garnet membranes comprising 4 wt. % MgO and 0 wt. % MgO, according to some embodiments. An increase of sintering temperature (1150° C. to 1300° C.) corresponds to a Li concentration decrease within the membrane due to enhanced Li loss at high temperature for both the 4 wt. % MgO and 0 wt. % MgO cases. However, the different trends of each curve indicate unique Li-loss process trends. Without MgO, lattice constant decreases with Li-loss while with MgO, the lattice constant increases with Li-loss or with a sintering temperature increase, and then plateaus. This lattice enlargement arises due to Mg doping into the garnet lattice (Mg-Ta-LLZO). Mg substitutes the Zr site, thereby freeing two Li sites. The additional Li atoms added into the garnet lattice increases its lattice constant. Both cubic phase content and sintering temperature-dependent Li content indicate that Mg-Ta-LLZO is a more stable and more Li-loss resistant garnet than Ta-LLZO.

### Example 6

### Cell Testing

All Li symmetric cells and the full battery were tested on a LAND CT2001A battery test system (Wuhan, China). The Li/garnet/Li symmetrical battery was subjected to a rate cycling test at an initial current density of 0.1 mA·cm⁻², followed by increments of 0.1 mA·cm⁻² to determine the critical current density (CCD) of the garnet. Four garnet composition samples were tested to measure CCD. Charge and discharge durations were set to 30 minutes. All battery tests were performed at 25° C. Samples for cell testing were prepared by powder pressing into pellet and pressure-less sintering method.

### Example 7

### Characterization Techniques

Morphology and Phase Analysis

Scanning electron microscopy (SEM) images were obtained by a scanning electron microscope (JEOL, JSM-6010PLUS/LA). X-ray powder diffraction (XRD) patterns were obtained by x-ray powder diffraction (Bruker, D4, Cu-Ka radiation, k=1.5415A) in the 20 range of 10-80° at room temperature. Inductively coupled plasma (ICP) measurements were conducted using a HF/HC104 fuming procedure (fume to dryness twice), then dissolve residue in HCl. Li analysis was conducted using a Perkin Elmer PinnAAcle 500.

Electrochemical Impedance Spectroscopy (EIS)

EIS was measured by AC impedance analysis (Solartron SI 1287) with a frequency range of 0.1Hz to 1MHz.

Thus, as presented herein, this disclosure relates to improved lithium-garnet composite ceramic electrolytes for enhanced grain boundary bonding of Li-garnet electrolytes in solid-state lithium metal battery applications. The enhanced grain boundary composition helps to resist harmful Li-dendrite growth.

Specifically, this application discloses a composition of MgO/garnet composite thin membrane where MgO is a second or minor phase material, located at the grain boundaries. Concentration of the MgO phase may vary in a range of 0.1 wt. % to 10 wt. %. Li-garnet in a cubic phase is the main phase. Some quantity of Mg doping is included in the Li-garnet besides any other original doping elements (e.g., Ta). Mg may substitute the Zr site of Li-garnet to give a final composite composition of MgO/Mg-LLZO (when LLZO is the starting material) or MgO/Mg-Ta-LLZO (when Ta-LLZO is the starting material). In some examples, the Li-garnet has a basic form of Li₇La₃Zr₂O₁₂, which can be doped with certain amount of In, Si, Ge, Sn, Sb, Sc, Ti, Hf, V, W, Te, Nb, Ta, Al, Ga, Fe, Bi, Y, Mg, Ca, or combinations thereof.

This application also discloses a process of making a thin membrane of the MgO/garnet composite. The process includes (1) MgO and garnet powder pre-treatments, (2) tape casting of the mixed powders of garnet, MgO and Li₂CO₃ (the excess Li source), and (3) sintering the green tapes into dense tapes. For the powder pre-treatment, MgO powder is preheated to remove any volatiles, while the garnet powder is air carbonated or acid treated to passivate its high reactivity with other tape casting slip components. Li₂CO₃ in the green tape is used as a Li source to compensate Li loss during sintering. It may also generate a liquid phase at high temperature that enhances the sintering. The composite garnet tape sintering is conducted at a temperature range of 1150° C-1250° C. for several minutes. The process disclosed herein allows the tape to be sintered in a large scale with a much-improved density.

The sintered garnet membranes have a high Li-ion conductivity (>10⁻⁴ S/cm), thickness from 30-150 μm, and a relative density is >95%.

Advantages include: (1) MgO in garnet helps to prevent garnet grain growth, thereby increasing thin membrane strength; (2) Excess Li inside garnet generates a liquid phase during sintering, which enhances the sintering process and increases density of the sintered structure; (3) too much liquid phase from excess Li also enhances abnormal grain growth—MgO inhibits this grain growth and enlarges the excess Li addition window for tape sintering; (4) MgO/garnet composite has a high Li-ion conductivity; (5) MgO in garnet increases critical current density; (6) MgO/garnet composite can be made in thin tape form by the disclosed tape casting method; (7) in the tape casting process, garnet passivation allows garnet to remain stable with the tape casting slip and as a result, the green tape lasts a much longer time; (8) MgO powder pre-treatment before tape casting allows the tape surface to be more smooth; and (9) cubic garnet phase in MgO/Mg-Ta-LLZO is more stable for Li deficiency than in Ta-LLZO.

It will be apparent to those skilled in the art that various modifications and variations can be made without departing from the spirit or scope of the claimed subject matter. Accordingly, the claimed subject matter is not to be restricted except in light of the attached claims and their equivalents.

What is claimed is:

1. A sintered composite ceramic, comprising:
a lithium-garnet major phase; and
a grain growth inhibitor minor phase,
wherein the grain growth inhibitor minor phase comprises a metal oxide in a range of 0.1 wt. % to 10 wt. % based on the total weight of the sintered composite ceramic.

2. The sintered composite ceramic of claim 1, wherein the lithium-garnet major phase comprises at least one of:
(i) Li₇₋₃ₐLa₃Zr₂LₐO₁₂, with L═Al, Ga or Fe and 0<a<0.33;
(ii) Li₇La_{3-b}Zr₂M_{b}O₁₂, with M═Bi, Ca, or Y and 0<b<1;
(iii) Li_{7,}La₃(Zr_{2-c}, N_{c})O₁₂, with N═In, Si, Ge, Sn, Sb, Sc, Ti, Hf, V, W, Te, Nb, Ta, Al, Ga, Fe, Bi, Y, Mg, Ca, or combinations thereof and 0<c<1, or a combination thereof.

3. The sintered composite ceramic of claim 2, wherein the lithium-garnet major phase comprises:
Li_{7-c}La₃(Zr_{2-c}, N_{c})O₁₂, with N═Ta, Mg, or combinations thereof, and 0<c<1.

4. The sintered composite ceramic of claim 1, wherein the metal oxide comprises: MgO, CaO, ZrO₂, HfO₂, or a mixture thereof.

5. The sintered composite ceramic of claim 4, wherein the metal oxide comprises MgO.

6. The sintered composite ceramic of claim 1, wherein the lithium-garnet major phase comprises at least 90 wt. % of a lithium garnet cubic phase.

7. The sintered composite ceramic of claim 1, wherein a maximum grain size measured for a population of grains representing at least 5% of a total grain population does not exceed an average grain size of the total grain population by more than a multiple of 20.

8. The sintered composite ceramic of claim 1, comprising a membrane having a thickness in a range of 30-150 μm.

9. The sintered composite ceramic of claim 8, wherein the membrane has a Li-ion conductivity of at least 10′ S/cm and a relative density of at least 90% of a theoretical maximum density of the membrane.

10. A ceramic electrolyte comprising at least the sintered composite ceramic of claim 1, wherein a critical current density (CCD) of battery cells comprising the ceramic electrolyte is at least 0.6 mA·cm⁻².

11. The ceramic electrolyte of claim 10, wherein the CCD of the battery cells is at least 1.0 mA·cm⁻² at room temperature.

12. A battery, comprising:
at least one lithium electrode; and
an electrolyte in contact with the at least one lithium electrode,
wherein the electrolyte is a lithium-garnet composite electrolyte comprising the sintered composite ceramic of claim 1.

13. A sintered composite ceramic, comprising:
a lithium-garnet major phase; and
a grain growth inhibitor minor phase,
wherein:
the lithium-garnet major phase comprises:
Li_{7-c}La₃(Zr_{2-c}, N_{c})O₁₂, with N=Ta, Mg, or combinations thereof, and 0<c<1, and
the grain growth inhibitor minor phase comprises MgO in a range of 0.1 wt. % to 10 wt. % based on the total weight of the sintered composite ceramic.

14. The sintered composite ceramic of claim 13, wherein the lithium-garnet major phase comprises at least 90 wt. % of a lithium garnet cubic phase.

15. The sintered composite ceramic of claim 13, wherein a maximum grain size measured for a population of grains representing at least 5% of a total grain population does not exceed an average grain size of the total grain population by more than a multiple of 20.

16. The sintered composite ceramic of claim 13, comprising a membrane having a thickness in a range of 30-150 μm.

17. A sintered composite ceramic, comprising:
a lithium-garnet major phase; and
a grain growth inhibitor minor phase, wherein the sintered composite ceramic comprises at least one of:
a Li-ion conductivity of at least 10⁻⁴ S/cm; and
a relative density of at least 90% of a theoretical maximum density of the membrane.

18. A method, comprising:
a first mixing of inorganic source materials to form a mixture, including a lithium source compound and at least one transition metal compound;
a first calcining conducted at a first temperature range of 800° C. to 1200° C.;
a second calcining conducted at a second temperature range of 1000° C. to 1300° C.;
a milling step of the mixture to reduce particle size;
a sieving step to obtain a powder having at least one dimension in a range of 0.01 μm to 1 μm.

19. A method of forming a composite ceramic, comprising:
forming a garnet powder including a lithium source compound and at least one transition metal compound;
passivating the garnet powder by at least one of air carbonation and acid treatment;
heating a metal oxide at a first temperature range of 500° C. to 1500° C.;
forming a slip composition comprising the passivated garnet powder and metal oxide;
tape casting the slip composition to form a green tape;
sintering the green tape at a second temperature range of 950° C. to 1500° C. to form the composite ceramic.
